(19) United States
(12) Patent Application Publication
(10) Pub. No.: US 2013/0068039 A1
(43) Pub. Date: Mar. 21, 2013

(54) SPECIMEN CONVEYANCE APPARATUS

(71) Applicants: Seon Young MYOUNG, Gyunggi-do (KR); Seong Chan PARK, Gyunggi-do (KR); Suk Jin HAM, Seoul (KR)

(72) Inventors: Seon Young MYOUNG, Gyunggi-do (KR); Seong Chan PARK, Gyunggi-do (KR); Suk Jin HAM, Seoul (KR)

(73) Assignee: SAMSUNG ELECTRO-MECHANICS CO., LTD., Gyunggi-do (KR)

(21) Appl. No.: 13/332,296

(22) Filed: Dec. 20, 2011

(30) Foreign Application Priority Data
Sep. 21, 2011 (KR) 10-2011-0095379

(51) Int. Cl. G01N 1/24

(52) U.S. Cl. 73/863.23

(57) ABSTRACT

Disclosed herein is a specimen conveyance apparatus including: a main body having a plate-like shape and including a storage chamber having a recess-like shape formed thereon; a cover member covering the main body; a sealing member inserted between the main body and the cover member and blocking the storage chamber and the outside; a suction pipe installed within the main body, having a suction valve, and sucking external air; a filter installed within the main body, removing a reactive gas and particulate foreign material from air sucked through the suction pipe, and allowing an inert gas to pass therethrough toward the storage chamber; a discharge pipe installed within the main body, having a discharge valve, and discharging a gas to the outside; and a pump discharging a gas present in the storage chamber to the outside through the discharge pipe.

### CROSS REFERENCE TO RELATED APPLICATION

This application claims the benefit of Korean Patent Application No. 10-2011-0095379, filed on Sep. 21, 2011, entitled “Specimen Conveyance Apparatus”, which is hereby incorporated by reference in its entirety into this application.

### BACKGROUND OF THE INVENTION

1. Technical Field

The present invention relates to a specimen conveyance apparatus.

2. Description of the Prior Art

According to a prior art specimen and product conveyance method, specimens and products are put in a plastic bag, a box, a bag, or the like, having a single space or several spaces demarcated by separators, and an inlet (or an opening) thereof is encapsulated or a cover thereof is put thereon, and then conveyed or transported.

Among the prior art conveyance apparatuses, a bag, which does not have any particular device other than a separator structure and a filler for reducing impact, has a structure that cannot effectively prevent surface contamination.

One of prior arts is Korean Patent Laid Open Publication No. 1996-0026309 entitled “Specimen Conveyance Apparatus for Surface Analysis”.

The specimen conveyance apparatus for a surface analysis is to transfer a specimen into surface analyzing equipment without any contamination, which includes a specimen holder support supporting a specimen holder therein, a specimen charging (or loading) container having a mounting bar formed at a lower portion thereof and connected to a specimen conveyance unit and having one side opened, a specimen charging container cover to cover the opened side of the specimen charging container, an airtightness maintaining unit for maintaining the atmosphere within the specimen charging container, and a vacuum unit vacuum-processing the interior of the specimen charging container when a specimen input opening is vacuum-processed.

In the prior art, after the specimen is installed within the charging container, the interior of the charging container is maintained in a vacuum state by using a vacuum unit to thus allow the specimen to be conveyed without contaminating a surface thereof.

However, since the interior of the charging container should be maintained in a vacuum state by using the vacuum unit in addition to the charging container, the prior art is inconvenient to use due to the additional equipment besides the charging container.

Also, since the interior of the charging container is configured as a single space, it is inconvenient to use while conveying a plurality of specimens.

In addition, since the interior of the charging container is maintained in a vacuum state, a foreign object or constituent components of the product having a high vapor pressure is evaporated, which may potentially distort the analysis results.

### SUMMARY OF THE INVENTION

The present invention has been made in an effort to provide a specimen conveyance apparatus capable of introducing external air into the apparatus and exhausting an internal gas to the outside by using a small, lightweight pump and allowing inert gases such as nitrogen, argon, or the like, to selectively flow into the apparatus by using a filter.

According to a preferred embodiment of the present invention, there is provided a specimen conveyance apparatus including: a main body having a plate-like shape and including a storage chamber having a recess-like shape formed thereon; a cover member covering the main body; a sealing member inserted between the main body and the cover member and blocking the storage chamber and the outside; a suction pipe installed within the main body, having a suction valve, and sucking external air; a filter installed within the main body, removing a reactive gas and particulate foreign material from air sucked through the suction pipe, and allowing an inert gas to pass therethrough toward the storage chamber; a discharge pipe installed within the main body, having a discharge valve, and discharging a gas to the outside; and a pump discharging a gas present in the storage chamber to the outside through the discharge pipe.

The filter may be a composite filter filtering oxygen, moisture, and hydrocarbon. The filter may be formed by combining a plurality of sub-filters each filtering oxygen, moisture, and hydrocarbon.

The sealing member may be an elastic O-ring.

The suction valve may be a solenoid valve.

The storage chamber may be divided into a plurality of section chambers, and further include a distribution pipe distributing air supplied from the filter into the plurality of section chambers; and an exhaust pipe providing an exhaust gas from the section chambers to the pump.

The distribution pipe may include: a main distribution pipe connected to the filter and receiving a gas from the filter; and a branch distribution pipe branched from the main distribution pipe, including a distribution valve, and connected to the storage chamber to supply a gas supplied from the main distribution pipe to a corresponding section chamber.

The branch distribution pipe may supply a gas to several section chambers.

The exhaust pipe may include: a main exhaust pipe connected to the pump and supplying an exhaust gas to the pump; and a branch exhaust pipe installed between the section chamber and the main exhaust pipe, including a branch valve, and supplying a gas discharged from the section chamber to the main exhaust pipe.

The pump may be a diaphragm pump.

The specimen conveyance apparatus may further include a power source unit receiving power from the outside and supplying the received power to the pump.

The specimen conveyance apparatus may further include a battery installed within the main body and supplying power to the pump.

The specimen conveyance apparatus may further include a locking member locking the main body and the cover member.

The specimen conveyance apparatus may further include a controller driving or stopping the pump according to a user's manipulation of a key manipulation unit, and turning on or off the suction valve and the discharge valve.

### BRIEF DESCRIPTION OF THE DRAWINGS

FIG. 1 is a perspective view of a specimen conveyance apparatus in a state in which the interior thereof is hermetically sealed according to a first embodiment of the present invention.

FIG. 2 is a perspective view of the specimen conveyance apparatus in a state in which the interior thereof is open according to the first embodiment of the present invention.

FIG. 3 is a top view of the specimen conveyance apparatus of FIGS. 1 and 2.

FIG. 4 is a side-sectional view of the specimen conveyance apparatus of FIG. 1.

FIG. 5 is a side-sectional view of the specimen conveyance apparatus of FIG. 2.

FIG. 6 is a top view of the specimen conveyance apparatus of FIG. 1 according to a second embodiment of the present invention.

FIG. 7 is a top view of the specimen conveyance apparatus of FIG. 1 according to a third embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In describing the present invention, a detailed description of related known functions or configurations will be omitted so as not to obscure the gist of the present invention.

Hereinafter, preferred embodiments of the present invention will be described in detail with reference to the accompanying drawings.

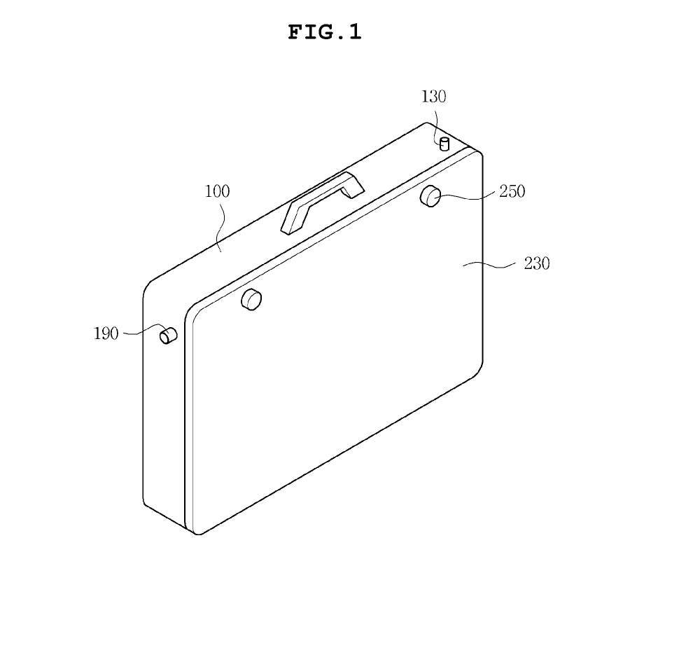

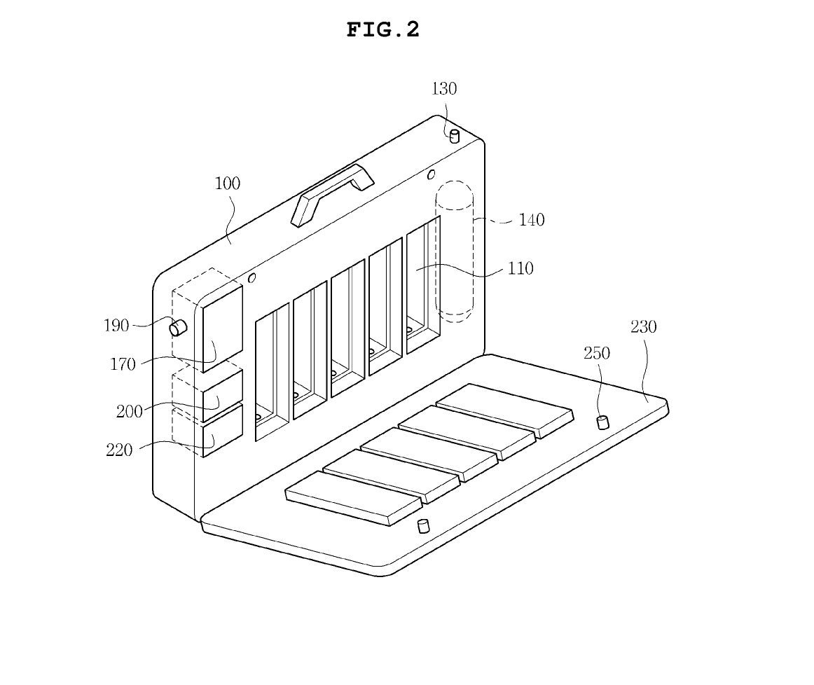

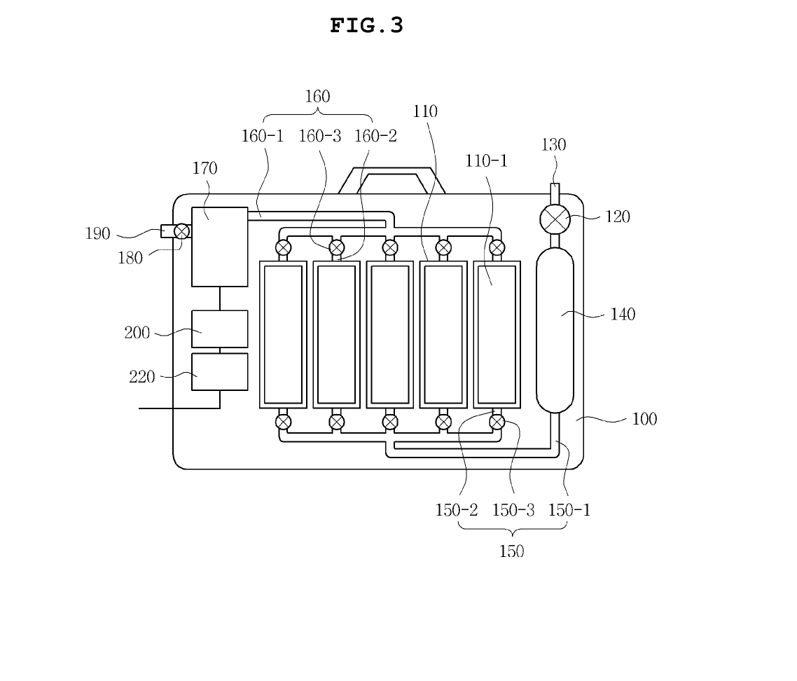

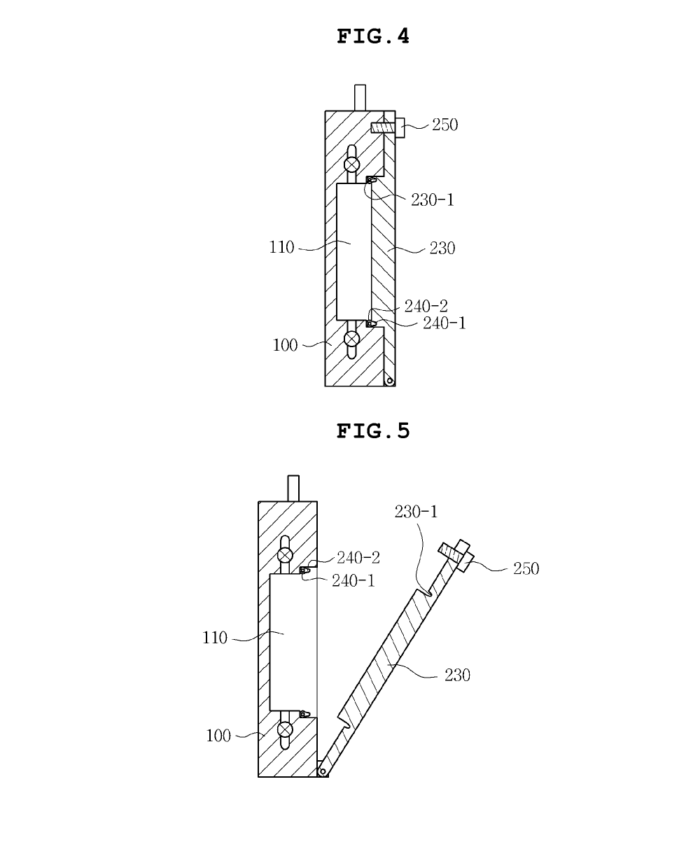

FIG. 1 is a perspective view of a specimen conveyance apparatus in a state in which the interior thereof is hermetically sealed according to a first embodiment of the present invention. FIG. 2 is a perspective view of the specimen conveyance apparatus in a state in which the interior thereof is open according to the first embodiment of the present invention. FIG. 3 is a top view of the specimen conveyance apparatus of FIGS. 1 and 2. FIG. 4 is a side-sectional view of the specimen conveyance apparatus of FIG. 1. FIG. 5 is a side-sectional view of the specimen conveyance apparatus of FIG. 2.

With reference to FIGS. 1 through 5, a specimen conveyance apparatus according to a first embodiment of the present invention includes a main body 100 having a storage chamber 110, a suction pipe 130 having a suction valve 120, a filter 140, a distribution pipe 150, an exhaust pipe 160, a pump 170, a discharge pipe 190 having a discharge valve 180, a power source unit 200, a controller 220, a cover member 230, a sealing member 240, and a locking member 250.

The main body 100 has a shape of a quadrangular plate, includes a storage chamber 110 formed as a recess therein, and has a handle attached to one side. Here, the handle may be a handle generally used for a bag type case, or the like, and may be formed to be moved for user convenience. A user may carry the specimen conveyance apparatus by using the handle attached to the side of the main body 100.

The main body 100 may be made of various materials including, for example, polymer, metal, or the like. The recesses formed on the main body 100 may have a rectangular (or right-angled) shape or may be formed to be sloped.

Meanwhile, the storage chamber 110 is formed within the main body 100, in which a specimen is mounted.

Selectively, a filler such as a sponge, or the like, having a recess corresponding to a specimen, may be disposed on the bottom surface of the storage chamber 110 in order to prevent the specimen from being directly in contact with the main body 100. In this case, however, if the specimen can be tightly attached and fixed in the main body 100, the filler such as a sponge, or the like, may be omitted.

As illustrated, the storage chamber 110 may be divided into several section chambers 110-1, and specimens from different environments may be mounted in the respective section chambers 110-1.

The section chambers 110-1 may be separated by separators, and in this case, since the section chambers 110-1 are separated environmentally by the separators, the environments of the mutually adjacent separated section chambers 110-1 does not affect each other. A fixing unit (not shown) for fixing a specimen may be provided in each of the section chambers 110-1.

The suction pipe 130, a pipe for sucking air from the outside, is connected to the filter 140 and includes a suction valve 120 for shielding.

The suction pipe 130, configured as a flow pipe, has a linear shape to allow air to flow smoothly therein, but it may also be formed to have a streamlined shape according to the characteristics of the internal structure of the main body 100.

The material of the suction pipe 130 may be metal, but the present invention is not limited thereto and the suction pipe 130 may be made of a rubber material having elasticity.

The suction valve 120 installed on the suction pipe 130 blocks internal and external air to maintain a certain level of pressure within the storage chamber 110.

The suction valve 120 may be a manual valve, and preferably, it may be a solenoid valve whose ON and OFF operation can be electronically controlled by the controller 220.

The filter 140 removes particulate foreign material or debris and a reactive gas such as an organic substance, oxygen, moisture, and the like, in the air sucked through the suction pipe 130, thus allowing an inert gas to pass therethrough to the storage chamber 110.

As the filter 140, a composite filter capable of simultaneously filtering various materials such as oxygen, moisture, hydrocarbon, or the like, is preferred, but a plurality of sub-filters each filtering a different material may be combined to be used.

The distribution pipe 150 distributes and injects a gas sucked through the filter 140 to the section chambers 110-1 of the storage chamber 110.

Preferably, the distribution pipe 150 may have a linear shape, but it may have a streamlined shape in terms of the structure of the main body 100. The distribution pipe 150 may be made of metal, or may be made of a rubber material having elasticity according to circumstances.

When the storage chamber 110 is divided into several section chambers 110-1, the distribution pipe 150 is implemented such that a gas is received through one main distribution pipe 150-1 from the filter 140 and then distributed through branch distribution pipes 150-2 branched from particular points toward the respective section chambers 110-1.

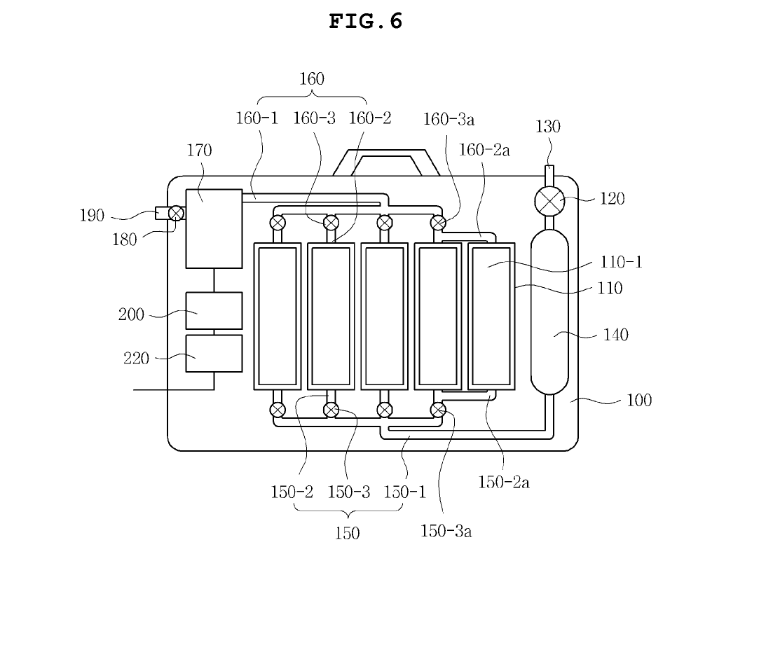

Of course, the distribution pipe 150 may be implemented such that one branch distribution pipe 150-2 supplies a gas to one section chamber 110-1 as shown in FIG. 3 or one branch distribution pipe 150-2a injects a gas into a plurality of section chambers 110-1 according to a different embodiment of the present invention as shown in FIG. 6.

When the distribution pipe 150 is implemented such that one branch distribution pipe 150-2a injects air into the plurality of section chambers 110-1, cost required for installation of an additional valve can be reduced and complexity of controlling can be lessened.

Of course, in such a case, it would be better for several section chambers 110-1, to which air is injected through one branch distribution pipe 150-2a, to include specimens under the same conditions.

Distribution valves 150-3, installed on the branch distribution pipes 150-2, respectively, serve to block a gas being injected. As the distribution valve 150-3, a manual valve may be used, but preferably, the distribution valve 150-3 may be a solenoid valve which can be electronically controlled by the controller 220.

The exhaust pipe 160 serves to supply gas present in the storage chamber 110 to the pump 170 so as to be exhausted to the outside. Preferably, the exhaust pipe 160 has a linear shape, but it may also have a streamlined shape in terms of the structure of the main body 100. The exhaust pipe 160 may be made of a metal material, and it may also be made of a rubber material having elasticity according to the circumstances.

When the storage chamber 110 is divided into several section chambers 110-1, a main exhaust pipe 160-1 of the exhaust pipe 160 may receive an exhaust gas through branch exhaust pipes 160-2 connected to the section chambers 110-1, respectively, and provide the received gas to the pump 170.

Here, exhaust valves 160-3 installed on branch exhaust pipes 160-2, respectively, serve to block a gas being injected. As the exhaust valve 160-3, a manual valve may be used, but preferably, the exhaust valve 160-3 may be a solenoid valve which can be electronically controlled by the controller 220.

The pump 170 serves to discharge the gas present in the storage chamber 110 to the outside. As the pump 170, a small, lightweight diaphragm pump is preferred, but any other types of pumps may also be used so long as they can be attached to a specimen conveyance apparatus, do not mar the portability of the specimen conveyance apparatus, and are free from contamination.

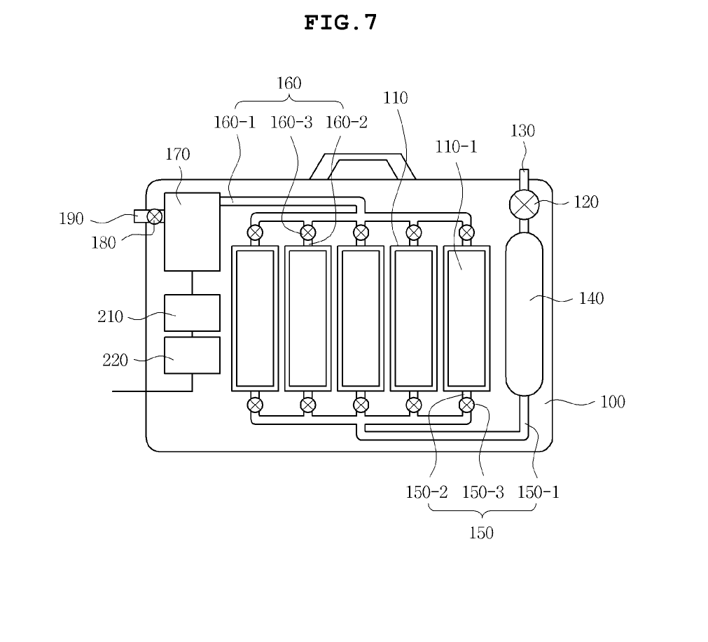

Basically, the pump 170 is operated upon receiving AC power supplied from the outside through the power source unit 200, but it may also be driven by using the battery 210 installed in the apparatus according to a third embodiment of the present invention as illustrated in FIG. 7.

The pump 170 is driven to discharge the gas present in the storage chamber 110 to the outside, and accordingly, the pressure of the gas present in the storage chamber 110 is lower than atmospheric pressure.

The discharge pipe 190, serving to discharge gas to the outside, is connected to the pump 170 and includes a discharge valve 180 for shielding.

The discharge pipe 190, configured as a flow pipe, has a linear shape to allow air to flow smoothly therein, but it may also be formed to have a streamlined shape according to the characteristics of the internal structure of the main body 100.

The material of the discharge pipe 190 may be metal, but the present invention is not limited thereto and the discharge pipe 190 may be made of a rubber material having elasticity.

The discharge valve 180 installed on the discharge pipe 190 blocks the interior and the exterior to maintain a certain level of pressure within the storage chamber 110.

The discharge valve 180 may be a manual valve, and preferably, it may be a solenoid valve whose ON and OFF operation can be electronically controlled by the controller 220.

The power source unit 220 lowers the voltage of power introduced from the outside such that it is available for the pump 170, and then supplies the same to the pump 170.

The power source unit 220 may include a transformer, or the like, and may also include a capacitor, or the like, to remove ripples, or the like, from power introduced from the outside and supply the same to the pump 170, whereby the pump 170 can be stably operated.

The controller 220 controls the suction valve 120, the distribution valve 150-3, the exhaust valve 160-3, the discharge valve 180, the pump 170, and the like. Namely, the controller 220 controls the suction valve 120, the distribution valve 150-3, the exhaust valve 160-3, the discharge valve 180, the pump 170, and the like, to discharge the gas present in the storage chamber 110 to the outside or allow an inert gas without an organic substance, or the like, to be introduced into the storage chamber 110 from the outside.

The cover member 230 may be disposed on the main body 100 to cover the specimens. The cover member 230 may be greater than the size of the storage chamber 110 in order to cover the storage chamber 110.

The cover member 230 may be made of various materials. For example, the cover member 230 may include polymer or metal.

The cover member 230 may include a trench 230-1 disposed on the bottom surface thereof in a facing manner along the vicinity of the edges of the storage chamber 110.

The sealing member 240 may be interposed between the main body 100 and the cover member 230. The sealing member 240 may be disposed along the edges of the storage chamber 110. For example, the sealing member 240 may compress the main body 100 in the vicinity of the storage chamber 110 to block an internal space between the specimen and the cover member 230 from the outside. In addition, the sealing member 240 may simultaneously compress the edges of the specimen to fix the specimen within the storage chamber 110. Accordingly, although the main body 100 is moved, the specimen is fixed, thus being prevented from being damaged.

The sealing member 240 may have elasticity in order to enhance airtight force thereof. For example, the sealing member 240 may include an elastic O-ring made of a rubber material.

The elastic O-ring may have a donut-like shape and may be used to hermetically close solid-phase materials. Accordingly, although the heights of the upper surfaces of the main body 100 are different, the sealing member 240 can be deformed according to the corresponding shape to effectively shield the internal space against the outside.

By hermetically closing the internal space against the outside, the specimen can be prevented from being contaminated by external moisture, or the like. Thus, the specimen can be stably kept in storage within the storage chamber 110.

In addition, in order to enhance elasticity, the sealing member 240 may include a void 240-1 therein. Thus, the sealing member 240 can be easily deformed. In addition, the sealing member 240 may include a projection 240-2 insertedly coupled to the trench 230-1. Accordingly, the sealing member 240 can be fixed without being moved. The projection 240-2 and the trench 230-1 may have various shapes such that they correspond to each other.

In addition, the sealing member 240 has a coated surface in order to help the specimen be adsorbed to or detached from a contact portion thereof. For example, the coated surface may include a polymer film. The polymer film may aid the sealing member 240 to be detached from the specimen when the cover member 230 is opened.

The locking member 250 may be provided to lock the cover member 230 and the main body 100. Accordingly, compressive force to the sealing member 240 between the cover member 230 and the main body 100 can be uniformly maintained

Thus, although the specimen conveyance apparatus is moved, the specimen can be stably fixed within the main body 100 with the internal space hermetically closed.

For example, the locking member 250 may include a screw-type locking member. The screw type locking member 250 may be used to lock (or fasten) the cover member and the main body or separate them by using a driver, or the like.

The operation of the specimen conveyance apparatus configured as described above according to an embodiment of the present invention will be described as follows.

First, the user may open the cover member 230 attached to the main body 100 by manipulating the locking member 250 and install a specimen, a product, or the like, in the storage chamber 110.

Next, the user may cover the main body 100 with the cover member 230 and fixes them with the locking member 250 so that the storage chamber 110 can be insulated from the outside by the sealing member 240.

And then, the user may manipulate a key to enable the controller 220 to control the suction valve 120, the distribution valve 150-3, the exhaust valve 160-3, and the discharge valve 180 to be opened and to control the pump 170 to be driven.

Of course, the user may manually control the suction valve 120, the distribution valve 150-3, the exhaust valve 160-3, the discharge valve 180, the pump 170, and the like.

Here, the user may control the controller 220 to introduce an inert gas into a desired section chamber 110-1 among the section chambers 110-1 of the storage chamber 110 and discharge an internal gas, and to this end, the user may control the controller 220 to turn on or off only one of the distribution valve 150-3 and the exhaust valve 160-3.

When the pump 170 is driven according to such an operation, the gas present in the storage chamber 110 is discharged to the outside, and only an inert gas whose organic substance, or the like, has been removed, is introduced to the inside through the suction pipe 130 and the filter 140 from the outside.

Thereafter, when the interior of the storage chamber 110 is sufficiently purged by and filled with the inert gas, the user may close the suction valve 120, the distribution valve 150-3, the exhaust valve 160-3, the discharge valve 180, and the like, and stop the driving of the pump 170.

In this manner, when the hermetically closed storage chamber 110 is sufficiently purged with the inert gas such as argon, nitrogen, or the like, to remove a contaminant therein, the storage chamber 110 can be effectively protected against adsorption of a gas molecule or a fine foreign material or object introduced from the air or environment or remaining therein, and corresponding chemical denaturation, oxidation, or the like.

Meanwhile, after closing the suction valve 120 and the distribution valve 150-3, the user may open the exhaust valve 160-3, the discharge valve 180, or the like, and drive the pump 170 in order to lower the internal pressure of the storage chamber 110 in comparison to atmospheric pressure.

In general, collision frequency of a particular gas with respect to a unit surface area can be expressed as follows according to a kinetic theory of gas.

$$\begin{matrix}f = {n [ {K}_{B} T / 2 π m ]}^{1 / 2} \\ = p / {[ 2 π {mK}_{B} T ]}^{1 / 2}\end{matrix}$$

Here, n is the number of gases per unit volume, k_{B} is a gas constant, T is temperature, m is mass of gas, and p is partial pressure of gas. According to the above equation, the collision frequency can be reduced by lowering the pressure of gas per unit volume.

As in the present embodiment, when a specimen is put in the hermetically closed (or airtight) storage chamber 110 and the internal pressure thereof is lowered by using the pump 170, frequency of collision between the specimen and the gas as a contaminant can be reduced to thus prevent damage to the specimen by the contaminant.

According to the preferred embodiments of the present invention, a phenomenon in which a foreign material is adsorbed to a surface of a specimen and a product or the surface of the specimen and the product is degenerated due to a reaction of oxygen and moisture is minimized, whereby the specimen and the product can be conveyed or transported for a long distance or for a long period of time while the surface of the specimen and a product is prevented from being contaminated and important information such as a fine structure, a chemical composition, or the like, is prevented from being distorted.

In this manner, since the specimen and the product can be conveyed or transported for a long distance or for a long period of time by preventing the specimen and the product from being degenerated, oxidized, and contaminated by a gas or a foreign material introduced from the atmosphere and environment, the specimen and the product can be analyzed in their original state (i.e., a state when they became defective or a state when they were collected or obtained), thus enhancing the reliability of the analysis results.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A specimen conveyance apparatus comprising:
a main body having a plate-like shape and including a storage chamber having a recess-like shape formed thereon;
a cover member covering the main body;
a sealing member inserted between the main body and the cover member and blocking the storage chamber and the outside;
a suction pipe installed within the main body, having a suction valve, and sucking external air;
a filter installed within the main body, removing a reactive gas and particulate foreign material from air sucked through the suction pipe, and allowing an inert gas to pass therethrough toward the storage chamber;
a discharge pipe installed within the main body, having a discharge valve, and discharging a gas to the outside; and
a pump discharging a gas present in the storage chamber to the outside through the discharge pipe.

2. The specimen conveyance apparatus as set forth in claim 1, wherein the filter is a composite filter filtering oxygen, moisture, and hydrocarbon.

3. The specimen conveyance apparatus as set forth in claim 1, wherein the filter is formed by combining a plurality of sub-filters each filtering oxygen, moisture, and hydrocarbon.

4. The specimen conveyance apparatus as set forth in claim 1, wherein the sealing member is an elastic O-ring.

5. The specimen conveyance apparatus as set forth in claim 1, wherein the suction valve is a solenoid valve.

6. The specimen conveyance apparatus as set forth in claim 1, wherein the storage chamber is divided into a plurality of section chambers, and further includes:
a distribution pipe distributing a gas supplied from the filter into the plurality of section chambers; and
an exhaust pipe providing a gas from the section chambers to the pump.

7. The specimen conveyance apparatus as set forth in claim 6, wherein the distribution pipe includes:
a main distribution pipe connected to the filter and receiving air from the filter; and
a branch distribution pipe branched from the main distribution pipe, including a distribution valve, and connected to the storage chamber to supply a gas supplied from the main distribution pipe to a corresponding section chamber.

8. The specimen conveyance apparatus as set forth in claim 7, wherein the branch distribution pipe supplies a gas to several section chambers.

9. The specimen conveyance apparatus as set forth in claim 6, wherein the exhaust pipe includes:
a main exhaust pipe connected to the pump and supplying an exhaust gas to the pump; and
a branch exhaust pipe installed between the section chamber and the main exhaust pipe, including a branch valve, and supplying an exhaust gas discharged from the section chamber to the main exhaust pipe.

10. The specimen conveyance apparatus as set forth in claim 1, wherein the pump is a diaphragm pump.

11. The specimen conveyance apparatus as set forth in claim 1, further comprising a power source unit receiving power from the outside and supplying the received power to the pump.

12. The specimen conveyance apparatus as set forth in claim 1, further comprising a battery installed within the main body and supplying power to the pump.

13. The specimen conveyance apparatus as set forth in claim 1, further comprising a locking member locking the main body and the cover member.

14. The specimen conveyance apparatus as set forth in claim 1, further comprising a controller driving or stopping the pump according to a user's manipulation of a key manipulation unit, and turning on or off the suction valve and the discharge valve.
